(19) United States
(12) Patent Application Publication
(10) Pub. No.: US 2003/0063575 A1
(43) Pub. Date: Apr. 3, 2003

(54) Order processing apparatus, order processing system and image photographing device

(75) Inventor: Naoto Kinjo, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/252,428

(22) Filed: Sep. 24, 2002

(30) Foreign Application Priority Data
Sep. 28, 2001 (JP) 2001-303526

(51) Int. Cl. H04L 12/16

(52) U.S. Cl. 370/265

(57) ABSTRACT

An order processing apparatus, which realizes an easy-ordering environment for ordering an image displayed on a display medium or an article that is a photographed object in that image. A customer photographs an image displayed on a television using a portable device and transmits the image data, together with information representing the content of the order, from the portable device to the order processing apparatus. The order processing apparatus specifies image data corresponding to the photographed image by collating the image data of the photographed image with the original image data stored in storage devices in a plurality of television broadcasting stations, and processes delivery of the printed image or the article that the customer photographed to the customer.

### BACKGROUND OF THE INVENTION

1. Field of the Invention

The present invention relates to an order processing apparatus, an order processing system and an image photographing device, and in particular, to an order processing apparatus that processes orders for images displayed on a display medium from customers and an image photographing device used in the order.

2. Description of the Related Art

The diversification of modes distributing and displaying image contents has been rapidly advancing in recent years, and image contents distributed in various distribution modes are displayed on various display media and presented to customers. Thus, a demand has arisen for realization of an environment in which it is possible to order photographic prints by designating a desired image, or to order a desired article by designating an image in which the requested article appears, among image contents displayed on a display medium. In order to enable customers to place an order using images displayed on the display medium, it is necessary for the customers to designate images and for the designated images to be identified.

Japanese Patent Application Laid-Open (JP-A) No. 10-171027 discloses an image printing system in which a customer designates frames to order for printing while watching visual programming on a television. After the customer designated frames to order, frame identification information and print order information are sent to a print finisher on-line via a print order device. The print finisher obtains original image data of the frames to be printed from an image database of a broadcasting station and prints the frames.

The technology disclosed in JP-A No. 10-171027 uses frame identification information, which is carried in non-image regions of television signals, to identify the images designated by the customer. This technology is based upon the premise that the customer owns a television that is able to decode the frame identification information and output the decoded information to the print order device. However, because conventional TVs do not have such functions, it is necessary for the customer to purchase a special television having the above functions. There has thus been the problem that, in order to realize an environment in which it is possible to order prints of optional frames within image programs displayed on a television, the customer must bear an enormous economic burden.

Japanese Patent Application No. 2000-320382 (unpublished) discloses related technology in which order format data is sent from an image terminal to the customer's order device, such as a Personal Digital assistant (PDA), so that the customer can create data for ordering an article. In this technique, however, the image terminal must have functions allowing if to communicate with the order device, to store the order format data in the image terminal, and to send the order format data to the order device when the customer places an order.

### SUMMARY OF THE INVENTION

In view of the aforementioned, it is an object of the present invention to provide an order processing apparatus and an image photographing device with which a customer can easily place an order corresponding to images displayed on a display medium.

A first aspect of the present invention is an order processing apparatus comprising an order receiving means for receiving image data, which represents a photographed image generated by photographing, and information including order information that forms an order from a customer. The order processing apparatus further comprises an order identifying means for identifying an ordered article from the image data received by the order receiving means. Furthermore, the order processing apparatus comprises an order processing means for carrying out, on the basis of the result of identification by the order identifying means, predetermined order processing in accordance with the order represented by the order information.

The image data is formed by photographing an image displayed on a display medium and/or an object for an order. The order identifying means can identify an image that is an object for an order from the image data received from the order receiving means. Further, the order identifying means can identify an ordered article corresponding to a photographed object represented by the identified image.

Alternatively, the order identifying means can further identify ordered articles relating to a photographed image from the identified image. The ordered article relating to the photographed image can be either a photographed image; and/or a creative work (literary work) relating to a photographed image; and/or an article advertised by a photographed image; and/or a creative work (literary work) relating to an article advertised in a photographed image.

The order processing apparatus may at least include a storing means for storing original image data corresponding to image data displayed on the display medium as original image data. The order identifying means may further identify the ordered article by using the image data stored in the storing means.

The order processing means may carry out, based on the order identified by the order identifying means, at least one of the following: Print processing of the image using original image data corresponding to the photographed image; processing orders of image printing to an outside agency; delivery processing of the original image data to the customer; recording processing of the original image data to a recording medium; and order processing of an article represented by the object of the photographed image to an outside dealer.

The customer photographs the image that represents an object for an order displayed on the display medium or the object of the order itself using a photographing means, and image data is generated from the photographed image. The order receiving means receives the photographic image data and the order information indicating the content of the order from the customer. Examples of the display medium include a television, an electronic board, electronic paper (see Japanese National Publication No. 11-502950), a computer, a cellular phone having a display on which an image can be displayed, and film-projecting equipment. Examples of the photographing means include a digital still camera, a cellular phone equipped with a photographing means, a PDA, a wearable computer, and a mobile computer.

At least one of the following is undertaken by the order identifying means based on the received photographic image data: Identification of an image of an object for an order; article identification of the photographic image itself that is an object for an order, which is represented by the photographic image data; identification of an article that is an object for an order represented by a photographed object in a photographic image; and identification of an article that is an object of an order relating to the photographic image. Identification of the image of an object for an order by the order identifying means may be carried out by storing image data of the image that is or may be displayed on the display medium in the storing means and by verifying the photographic image data stored in the storing means.

Further, identification of an article that is an object for an order represented by a photographed object in a photographic image can be carried out by, for example, storing article identification information for identifying the aforementioned article(s) to the image data of the photographed object that might be an order, and the image data is image data of a photographed object that corresponds to articles that might be ordered, from a plurality of image data that is or might be displayed on a display medium. Identifying information for identifying the aforementioned article(s) is stored, and based upon the result of the identification of the image of an object for an order, the corresponding article identification information can be obtained.

Furthermore, identification of the article represented by the photographed object in the photographic image is undertaken by first storing in the storing means the image data of a plurality of articles that have, for example, the possibility of being photographed by a customer as objects for an order, attached with corresponding article identification information for identifying each article. Then by collating the photographic image data with all data stored in the storing means, article identification information corresponding to the article that is the same as the photographed image as a photographed object can be identified from the plurality of images stored in the storing means.

Additionally, identification of an article relating to the image of an object for an order can be carried out by first storing the attached corresponding article identification information for identifying the aforementioned article to the data of images including related articles that are possible to be ordered from data of images that are or can be displayed on the aforementioned displaying means. Based on the result of the image identification, the corresponding article identification information can be obtained. In addition, as an article relating to an image of an object for an order, an article contained in a scene from a dynamic image of objects to be ordered can include a video movie or a drama, or video game software whose use allows playing of dynamic images that are recorded on a recording medium, such as video tape, DVD, CD-ROM, and the like. Also included is an image for an object for an order from a scene of a dynamic image such as an image from a commercial that advertises an article, and the related articles thereto such as creative works, which can include movies, dramas, CDs with music from video game software, as well as original works such as books upon which movies and dramas are based. The identifying means can be configured so as to identify at least one of the above-mentioned articles as an article relating to an image of an object for an order

The order processing means, based on the identification result by the order identifying means, carries out predetermined processing in accordance with the order content from the customer represented by the received order information. Thus, the order processing means can process the order from the customer corresponding to the image displayed on the display medium.

In accordance with the first aspect of the present invention, even when the customer orders an object of an image displayed on a display medium, neither the image of an object for an order, nor the information for identifying the article as a photographed object in the image as an article is received from the display medium. This is also the case with information for identifying articles related to the image of an object for an order. All of these functions are achieved simply by photographing an image of an object for an order, so no specially configured display means is necessary. Also, customers can order an exhibited article simply by photographing the object for an order. Thus, the first aspect of the present invention provides an environment in which the customer can easily place an order.

The predetermined processing in the first aspect of the present invention may be the following: Printing using the image data of the original image of an object for an order identified by the identifying means; the order of said prints to an outside agency; the transfer of the original image data of an image of an object for an order to the customer; recording original image data of an image that is an object for an order to a recording medium; and the order of the article identified by the identifying means. The original image data of the plurality of images, which are or may be displayed on the display medium, can be stored in the storing means and can be read out from the storing means based on the result of the identification of the image. Before being delivered to the customer, the original image data may be subjected to a predetermined image processing, such as enlargement/reduction, trimming, or image processing to improve image quality.

There are also cases where the image shows a plurality of candidate images of objects for an order, such as the image shown by the photographic image data is a plurality of images juxtaposed on an image, and just one portion of a photographed image is the image of an object for an order. In such cases, it is preferable that the order receiving means further receive information used for specifying the image to be ordered, and the order identifying means or the order processing means determine the image to be ordered based on the information that the order receiving means received.

The information used for specifying the image of an object for an order may indicate the image to be ordered among a plurality of candidate images, or may be photographic image data generated by the customer re-photographing only the image of the photographed object of an order from among a plurality of candidate images. Hence, even when there is a plurality of candidate images in the image represented by the photographic image data, the order identifying means can verify the image of the object for an order more accurately.

As described above, identification of the photographed image can be carried out by first storing an image of an object for an order displayed on a displaying means that is or may be displayed on the display medium in the storing means. The aforementioned identification can also be carried out by collating photographic image data with the data stored in the storing means. When there is a large number of images to be collated within the storing means, however, it is very difficult to identify images only by collation.

Taking this into consideration, the order receiving means may receive at least one of date/time information and the place information of photographing by the customer. The order identifying means may identify the image that is an object for an order by extracting the image data that may correspond to the photographed image and is specified by at least one of the date/time information and the place information using the image data stored in the storing means, and then collating the extracted image data with the photographic image data.

The date/time information of photographing may be generated by a clock means incorporated in the photographing means. The place information of photographing may be generated by a position sensing means incorporated in the photographing means. The position sensing means may sense the current position using, for example, a GPS (Global Positioning System). When the photographing means generates the date/time information and the place information, the order identifying means may obtain the time and place information by receiving them together with the photographic image data from the photographing means.

The order identifying means identifies the photographed image from the photographic image data displayed on a display medium, or from the plurality of image data that might be displayed, which is stored in the storing means. Thus, the image to be collated with can be specified by at least one of the date/time information and the place information of photographing. Hence, the photographed image that is an image of an object for an order can be narrowed down to, extracted, and identified in a short period of time.

When the display medium is a television or film-playing equipment, the image displayed thereon may be a dynamic image (e.g., video), which is displayed in accordance with a predetermined schedule. In this aspect, the image to be collated with can be specified by the date/time information of photographing. For example, the photographed image can be identified by extracting, from a plurality of dynamic image data that is or may be displayed on the display medium and is stored in the storing means, the image data that may be the image corresponding to the photographed image and is specified by at least one of the date/time information and the place information of photographing that the order receiving means received, and then collating the image data in the extracted image group with the photographic image data. In this fashion, the image of an object for an order can be identified.

When the display medium is a television, a dynamic image on the distribution channel that the customer selected among a plurality of channels for distributing dynamic images in accordance with a distribution schedule determined for each channel may be displayed on the display medium. In this aspect, each dynamic image data distributed on each distribution channel is stored in the storing means. The order identifying means may extract, among a plurality of images represented by the dynamic image data, the image group distributed around the time indicated by the obtained date/time information on the distribution channel basis, and then collate the image data of the extracted image group with the image data of the photographed image.

The display medium may be located at a predetermined place and administrated by an administrator, such as is the case with an electronic board. In this aspect, the image to be collated with can be specified by using the place information to specify the display medium from which the image was photographed. For example, the order identifying means may identify the image by receiving at least one of date/time and place information of photographing, specifying the display medium used, from which the customer photographed the image based on the place information, and extracting, from the storing means, the image data of the image that may correspond to the photographed image based on the specification of the display medium.

Further, displayed objects that are articles for an order are photographed by the customer, and the order receiving means also receives the place information that represents the photographing place. The identifying means further identifies image data of an article as a photographed object in the photographic image by extracting the image data, which is data of an article that may be a photographed object specified by using the place information, from the storing means that stores a plurality of image data of articles that may be photographed by the customer as images of objects for an order. The extracted image data is collated with the photographic image data. It is preferable for the identifying means to be configured so as to identify image data in such a manner described above.

The extracted image data is then collated with the photographic image data, and the article as a photographed object can thus be identified. Hence, even if the possible images of articles photographed by the customer as an order (image data stored in the storing means) vastly increases, the image of the verified object can be narrowed down with the place information, and the article as a photographed object in a photographic image can be identified in a short period of time.

The image displayed on the display medium may include a first identification image used for identifying each image. The order identifying means may identify the photographed image by extracting the first identification image included in the received image data. Because the order identifying means identifies the photographed image by extracting the first identification image, the order identifying means does not need to obtain the time or place information. Thus, the photographed image can be identified easily and in a short period of time.

When a dynamic image is displayed on the display medium, an identification code, such as a barcode, which includes information used for identifying each frame, may be added to each frame image of the dynamic image as the first identification image. In this aspect, the order identifying means can identify the photographed image based on the identification code extracted from the received photographed image.

Article identification information of an article as a photographed object in photographic image represented by image data, such as an image that is or can be displayed on a display medium, can be stored in the storing means. Article identification information for identifying an article as a photographed object corresponding to each individual image is stored, and the order identifying means, upon identifying the photographed image, can carry out identification based on stored article identification information stored with the corresponding identified image data.

Identification of the article as a photographed object in an image represented by photographic image data may also be carried out as follows. The image displayed on the display medium may have a second identification image attached to it that is used for identifying an article that is an object of the image. The order identifying means has a special characteristic in that it can extract the attached second identification image from the image represented by the image data that the order receiving means received, and identify the article as a photographed object in an image based on the second identification image.

Because the second identification image is attached to the image displayed on the display medium, the order identifying means can easily identify the article as a photographed object in an image, which is the object of the photographed image, by extracting the second identification image, without identifying the image that is an object for an order. Also, regarding article identification through a photographed object in a photographic image, a display member that indicates identification information for identifying an article can be placed near articles that might be photographed by a customer for an order. The identifying means can be configured to identify an article that is a photographed object in a photographic image based on the identification information of the extracted image section. Thus, based on the identification information shown in the portion of the image that contains the displaying member, identification of the article as a photographed object in an image for an order can be carried out easily without identifying the photographic image itself.

A second aspect of the present invention is an order processing system comprising: an order receiving device for receiving image data, which represents a photographed image generated by photographing, and information including order information that forms an order from a customer; an order identifying device for identifying an ordered article from the image data received by the order receiving device; and an order processing device for carrying out, based on the result of identification by the order identifying device, predetermined order processing in accordance with the order represented by the order information.

A third aspect of the present invention is an image photographing device, used together with the order processing apparatus or the order processing system, comprises a photographing means for photographing an image or an object of an order displayed on the display medium and generating image data of the image; an inputting means for inputting order information in accordance with the image photographed by the photographing means; and a transmitting means for transmitting the image data representing the photographed image and the inputted order information to the order processing apparatus or the order processing system.

The image photographing device of the present invention comprises the photographing means that makes the photographing of the image displayed on the display medium or the object for an order possible, the inputting means for inputting the contents of the customer's order that are photographed by the photographing means relating to the photographed images. The photographic image data and the order information inputted via the inputting means, are sent to the order processing apparatus or the order processing system. Based on the received information, at least one of identification of a photographed image that is an object for an order; or identification of an article as a photographic image represented by photographic image data or identification of an article as a photographed object in an image that is an object for an order; or identification of an article relating to the aforementioned photographed image of an object for an order is carried out. Based on the identification results, predetermined processing in accordance with the order contents from the customer is made possible.

The customer can place an order corresponding to an image or an object for an order he/she photographs, by photographing an image to be ordered displayed on the display medium using the photographing means or photographing the object for an order using the photographing means, and inputting the order information via the inputting means. Accordingly, with the order processing apparatus of the present invention, the customer can easily place an order corresponding to images displayed on a display medium without requiring any specially structured display medium.

### BRIEF DESCRIPTION OF THE DRAWINGS

FIG. 1 is a block diagram schematically illustrating an order processing system relating to an embodiment of the present invention.

FIG. 2 is a flowchart showing an image photographing process conducted on a portable device relating to the embodiment of the present invention.

FIGS. 3A to 3E are diagrams each showing an exemplary screen displayed on a display of the portable device relating to the embodiment of the present invention.

FIGS. 4A to 4D are diagrams showing exemplary images photographed in accordance with the image photographing process relating to the embodiment of the invention.

FIG. 5A and FIG. 5B are flowcharts showing an order receiving process relating to the embodiment of the invention.

FIG. 6 is a flowchart showing an order receiving process relating to a second embodiment of the invention.

FIGS. 7A and 7B illustrate other examples of display screens displayed on a display of the portable device.

### DESCRIPTION OF THE PREFERRED EMBODIMENTS

Referring now to the drawings, exemplary embodiments of the present invention will be described.

First Embodiment

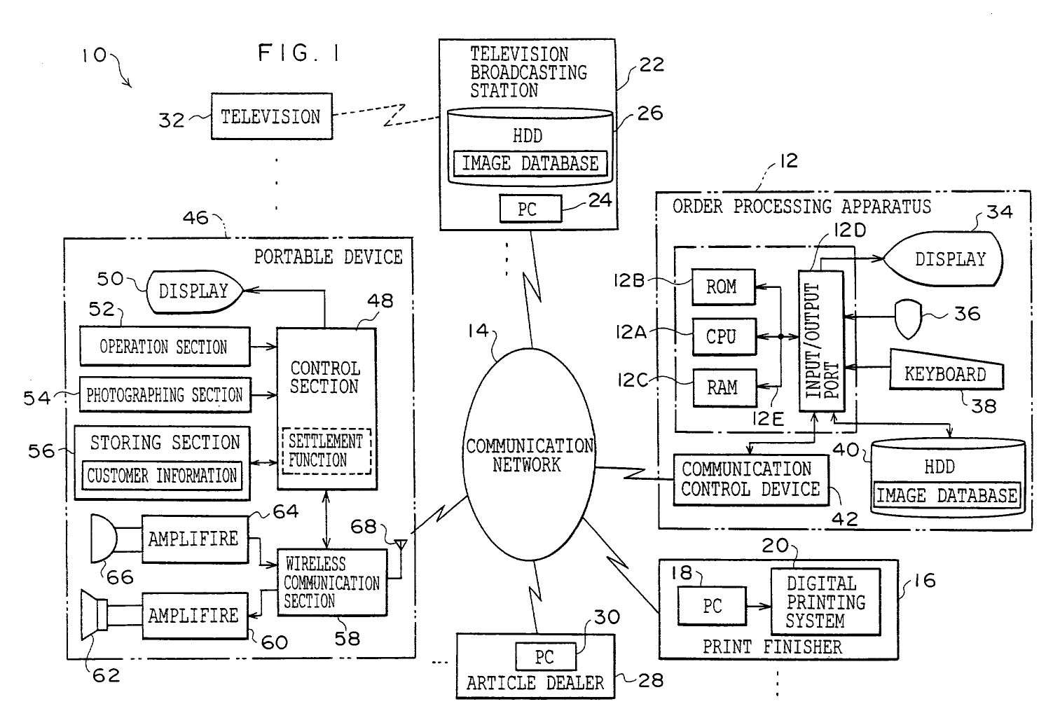

FIG. 1 illustrates an order processing system 10 relating to a first embodiment of the present invention. The order processing system 10 includes an order processing apparatus 12 relating to the present invention. The order processing apparatus 12 comprises a computer such as a work station and includes a CPU 12A, a ROM 12B, a RAM 12C, an input/output port 12D, which are linked by a bus 12E, and input/output devices such as a display 34 (CRT, LCD, or the like), a mouse 36 and a keyboard 38, a hard disk drive (HDD) 40, and a communication control unit (such as a modem or a router) 42, each of which is connected to the input/output port 12D.

An order receiving program (described later), with which the CPU 12A processes orders, is preinstalled in the HDD 40. Since the CPU 12A executes the order receiving program, the computer comprised by the order processing apparatus 12 functions as an order processing apparatus relating to the present invention.

The communication control unit 42 is connected to a communication network 14. The communication network 14 includes a portable terminal network, a public telephone network, a high-speed, large-capacity dedicated communication network or a computer network such as the Internet. Computers or personal computers (PCs) 18 of many nationwide print finishers 16, PCs 24 of a plurality of television broadcasting stations 22, and PCs 30 of a plurality of article dealers 28 are also connected to the communication network 14.

The print finisher 16 has a digital printing system 20 comprising equipment such as a film scanner for reading images recorded on a photographic film and a digital printer for conducting print finishing by recording images represented by image data on a recording material such as photographic paper. The digital printing system 20 is connected to the PC 18 and conducts print finishing using the image data that the PC 18 received via the communication network 14.

The television broadcasting station 22, to which one or more channels are allocated, broadcasts (i.e., distributes) video signals used for displaying images (dynamic image) on a television 32 in accordance with broadcasting schedules determined for each channel. An image (dynamic image) of a channel selected from among many channels by a viewer (i.e., a customer of the order processing system 10 ) at the receiving end is displayed on the television 32 so that an image to be ordered is presented to the customer.

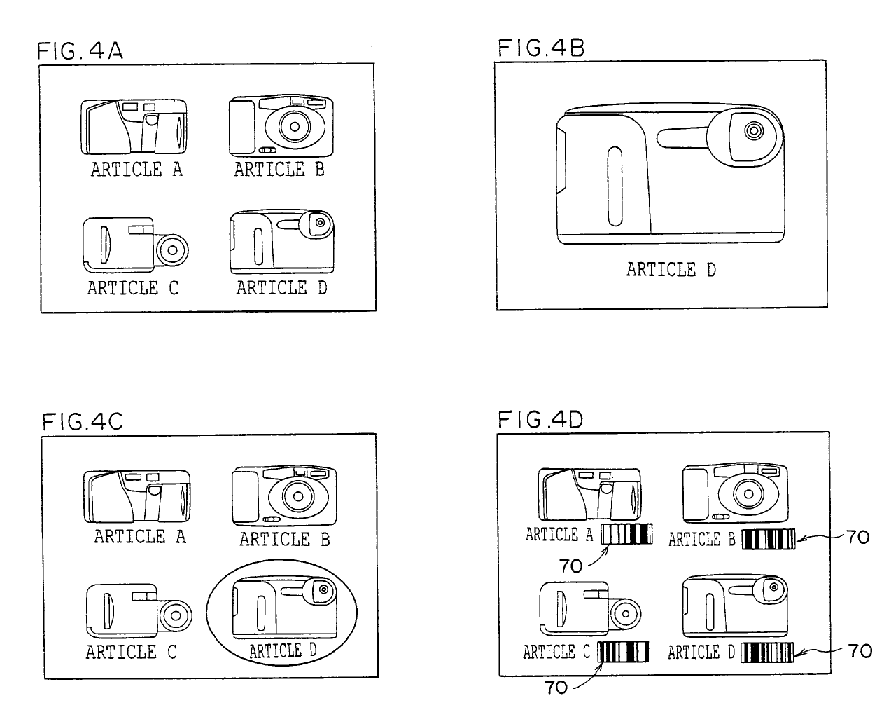

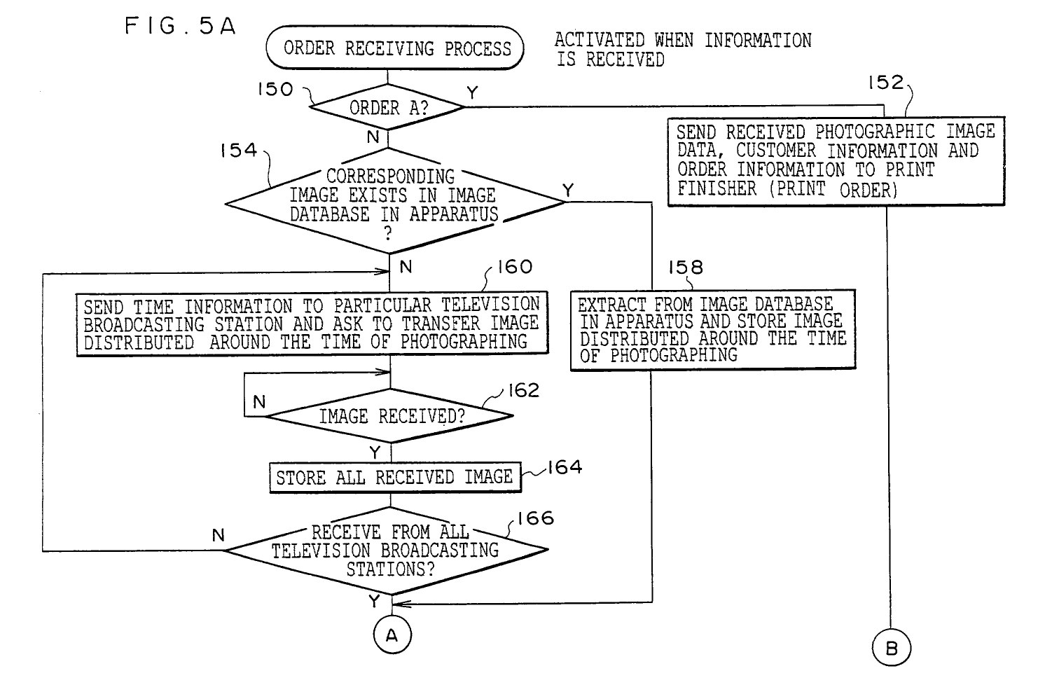

Each television broadcasting station 22 sends dynamic image data (original image data) that is displayed on the television 32 via the broadcast video signals is correlated with the broadcast time and stored in an image database in the HDD 26, which is connected to the PC 24. The HDD 26 corresponds to a storing means of the present invention. The images that the television broadcasting station 22 broadcasts may include images showing articles dealt in by the article dealer 28 as shown in FIG. 4A. The articles in the images are displayed for a predetermined period of time and the customer can order them via facsimile or telephone. Dynamic image data corresponding to these images includes article information, such as an article ID and an article dealer ID. The article information corresponds to the article identification information of the present invention.

Customers of the order processing system 10 have a portable device 46 relating to the present embodiment. The portable device 46 is a conventional cellular phone equipped with a photographing means and data communication means, and has a predetermined image photographing program (described later) installed therein. The portable device 46 corresponds to the image photographing device of the present invention.

The portable device 46 has a control section 48, which includes a CPU. A display 50, an operating section 52, a photographing section 54, a storing section 56, and a wireless communication section 58 are connected to the control section 48. The display 50 is a LCD or the like and displays various information including images. The operating section 52 includes a power switch, a ten-key numeric keypad, and the like. The photographing section 54 is used for photographing objects. Connected to the wireless communication section 58 are a speaker 62 via amplifier 60, a microphone 66 via an amplifier 64, and an antenna 68.

The photographing section 54 consists of a photographing element such as a CCD, a lens for focusing light and projecting an image of the object on a light-receiving surface of the photographing element, and a signal processing section which amplifies signals outputted from the photographing element and converts them into digital data (photographic image data). Customer information such as an owner (customer) ID, name, and address of the owner of the portable device 46, is stored in the storing section 56 in advance. The photographing section 54 corresponds to the photographing means, and the operating section 52 corresponds to the inputting means of the present invention.

The wireless communication section 58 carries out wireless communication with base stations connected to a wired public telephone network via the antenna 68 under control of the control section 48. The wireless communication section 58 uses an electromagnetic wave of a frequency that is predetermined for communication with cellular phones. The wireless communication section 58 can also communicate with the order processing apparatus via the communication network 14. The control section 48 may have a settlement mechanism as shown by a broken line in FIG. 1. A settlement procedure may by of pre-paid type or credit type. This settlement mechanism, which will be described later, allows customers to complete payment at the time of order. Individual authentication and settlement may be conducted by a third party.

An operation of the first embodiment will now be described. The customer of the order processing system 10 can order printing of an image photographed using the photographing section 54 of the portable device 46 (hereinafter referred to as “Order A”). The customer can also order printing by using original image data of the image he/she photographed on the screen of the television 32 using the photographing section 54 of the portable device 46 (hereinafter referred to as “Order B”). Further, the customer can order an article which is an object of an image is displayed on the screen of the television 32 (hereinafter referred to as “Order C”).

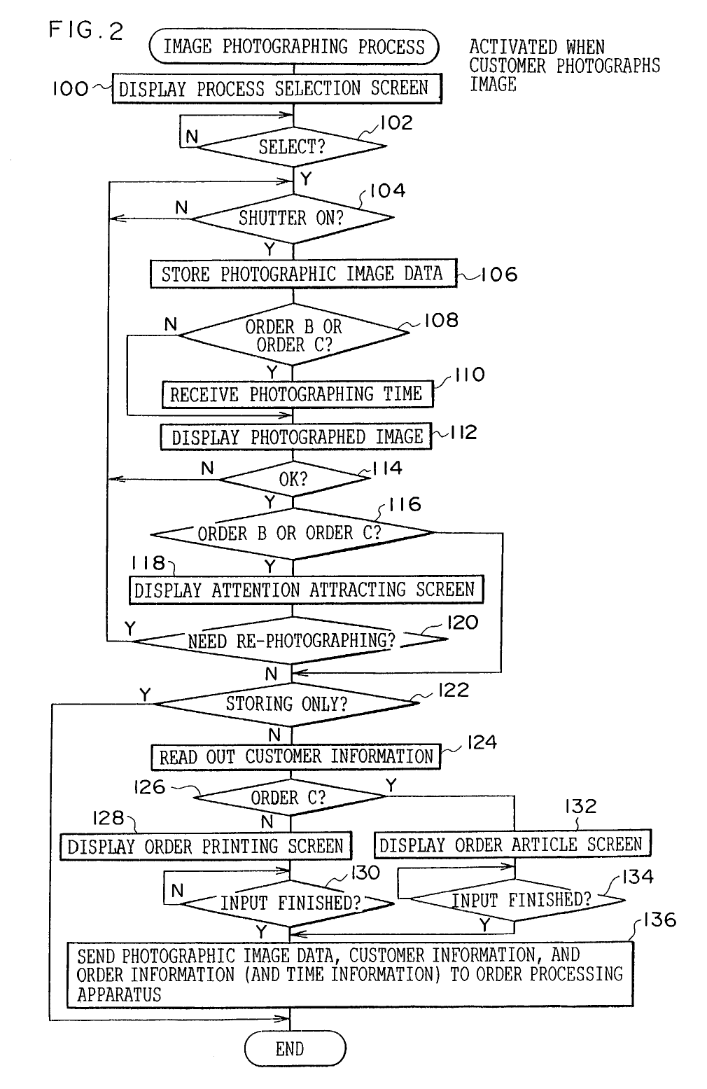

Referring to the flowchart in FIG. 2, the image photographing process will be described. When the customer photographs an object with the photographing section 54 of the portable device 46, the control section 48 (i.e., the CPU of the portable device 46 ) executes image photograph processing with the image photographing program installed in the storing section 56. The image photographing program may be preinstalled in the storing section 56 of the portable device 46 at the time of manufacture, or may be installed when, for example, the customer applies for use of the order processing system 12. In the latter case, the image photographing program may be downloaded from a predetermined server in the communication network 14 or from the order processing system 12 and installed in the storing section 56. The image photographing program is executed by the control section 48, i.e., the CPU, when the customer photographs an object using the photographing section 54 of the portable device 46.

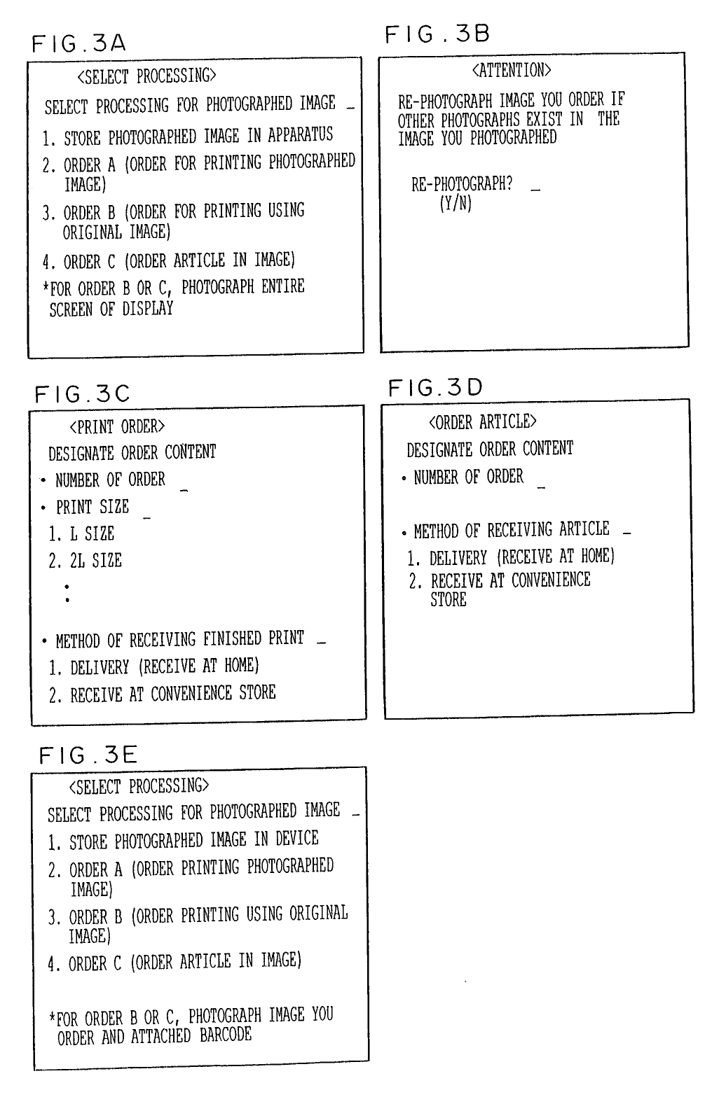

In step 100, a process selection screen, as shown in FIG. 3A, is displayed on the display 50. The process selection screen is a screen with which the customer can select processing with respect to an image to be photographed before photographing the image. The exemplary screen of FIG. 3A includes four alternatives that the customer may choose from: storing, in the storing section 56 of the portable device 46, photographic image data of an image of a scene the customer photographed (first processing); ordering prints using photographic image data of an image of a scene the customer photographed (second processing, “Order A”); ordering, on the basis of photographed image data obtained by the customer photographing an image displayed on the television 32, printing using original image data of the image (third processing, “Order B”); and ordering, on the basis of photographed image data obtained by the customer photographing an image displayed on the television 32, an article that is an object in an image (fourth processing, “Order C”).

Next, in step 102, it is determined whether an alternative has been selected or not, and the sequence remains on standby until the result becomes affirmative. After the customer confirms the process selection screen on the display 50 and selects one of the alternatives by operating the operating section 52, the result of step 102 is affirmative, and the sequence continues to step 104. In step 104, it is determined whether the key, among the many keys provided in the operating section 52, that functions as a shutter activator during photographing is turned ON (i.e., activated), and the sequence stands by until the result becomes affirmative.

When the customer selects the first or second processing, the customer photographs the desired scene by activating the shutter. When the customer selects the third (Order B) or the fourth processing (Order C) as processing for the photographed image, the customer photographs an image by activating the shutter after adjusting the direction of the portable device 46 and the distance between the portable device 46 and the display screen of the television 32, so that the entire screen fits within the shooting range of the photographing section 54, in a state in which an image for which the customer wishes to obtain photographic prints or an image including as a photographed object an article that the customer wishes to obtain is displayed on the television 32, as shown in the message displayed on the order processing screen of FIG. 3A. When a zoom lens is used in the photographing section 54, the zoom magnification may be adjusted instead of varying the actual distance between the photographing section 54 of the portable device 46 and the television 32.

Once the shutter is activated, the result of step 104 is affirmative, and the sequence continues to step 106. In step 106, the photographic image data outputted from the photographing section 54 is stored (saved) in the storing section 56. In step 108, it is determined whether the customer has selected Order B or Order C in response to the processing for the photographed image. When the result is negative, the sequence continues to step 112. However, when the result is affirmative, the sequence moves to step 110, where the date/ time information indicating the current date and time of photographing is received by the clock function (calendar function or timer function) incorporated in the control section 48. Then, the date/time information is temporarily stored in the storing section 56, and the sequence continues to step 112.

In the next step 112, the image represented by the photographic image data stored in the storing section 56 in step 106 is displayed on the display 50. A message is displayed on the display 50 that asks the customer whether or not the displayed image is appropriate (or if the customer wishes to retake the photograph). In step 114, it is determined whether the photographed image is appropriate or not based on the information the customer input via the operating section 52 after confirming the message. When the result of step 114 is negative, the photographic image data (and the date/time information obtained in step 110 ) is discarded and the sequence returns to step 104, where the previous steps are repeated. In this case, the customer can re-photograph the object in question.

When the result of step 104 is affirmative, the sequence continues to step 116, where it is determined whether the photographic image selected by the customer corresponds to Order B or to Order C. When the result of step 116 is negative, the sequence continues to step 122. When the result of step 116 is affirmative, the sequence continues to step 118, where an notice screen as shown in FIG. 3B is displayed on the display 50.

As described before, in Order B and C, because the customer photographs an image with the entire screen of the television 32 being within the photographing range of the photographing section 54, the possibility exists that a plurality of candidate images to be ordered will be displayed on the screen. In such cases, it is difficult for the apparatus to determine which one of the images is to be ordered. For example, articles A to D are displayed in FIG. 4A. In this case, a message is displayed on the notice screen asking the customer to re-photograph only the images to be ordered as shown in FIG. 3B.

In the next step 120, it is determined whether the images to be ordered must be re-photographed, based on the information the customer inputted via the control section 52. When the result is negative, the sequence continues to step 122. However, when the result indicated is affirmative, the sequence returns to step 104 and the previous steps are repeated. The customer re-photographs only the images of the objects to be ordered after adjusting the direction of the portable device 46 and the distance between the portable device 46 and the screen of the television 32 so that amongst the plurality of images, only the image(s) of the objects to be ordered are within the photographing range of the photographing section 54.

For example, an image represented by the photographic image data obtained by the first photographing is shown in FIG. 4A. When the customer wants to order the article D (i.e., using Order C), the customer re-photographs the image as shown in FIG. 4B, and the photographic image data of this image is also stored in the storing section 56.

In the next step 122, it is determined whether the customer has selected the first processing (only saving the photographic image data in the storing section 56). When the result is affirmative, the image photographing process ends because the photographic image data was already saved in step 106.

When the result of step 122 is negative (i.e., the customer has selected one of the second {Order A} to the fourth {Order C} processing steps instead of the first processing step), the sequence continues to step 124. In step 124, the customer information is read out from the storing section 56. In step 126, it is determined whether the customer has selected the fourth processing (Order C) or not. When the result is negative, the sequence continues to step 128, where a print order screen is displayed on the display 50.

The customer configures the contents of the Orders A and B (print order) on the print order screen. In the example in FIG. 3C, multiple alternatives are displayed for each item, such as “number of prints ordered” for designating the number of the photographic prints to be produced, “print size” for designating the size of the print to be produced, and “receiving method” for designating the method by which the customer will receive the finished print. The customer can set the desired content of the print order by selecting an alternative for each item. In step 130, it is determined whether or not the customer has completed inputting the desired settings, and the sequence stands by until the result becomes affirmative. After the customer has completed inputting the print order contents, the result of step 130 is affirmative and the sequence continues to step 136.

When the result of step 126 is affirmative, the sequence continues to step 132, where an article order screen such as the one shown in FIG. 3D is displayed on the display 50. The customer sets the content of the Order C (article order) on the article order screen. In the example illustrated in FIG. 3D, alternatives are displayed for each item, such as “number of articles ordered” for designating the number of articles to be delivered, and “article receiving method” for designating the address to which the article is to be delivered (i.e., the method of receiving the article). The customer can set the content of the article order by selecting an alternative for each item. In step 134, it is determined whether or not the customer has completed inputting the desired settings, and the sequence stands by until the result becomes affirmative. After the customer has completed inputting the article order contents, the result of step 134 is affirmative, and the sequence continues to step 136.

In step 136 of FIG. 2, the photographic image data and the customer information is read out. The photographic image data is stored in the storing section 56 in step 106 after the order type information (i.e., the information indicating Order A, B or C) in step 128 or step 132 is attached to the order content information set by the customer (generally referred to as “order information”). The customer information is stored in the storing section 56 in advance. When the order type is Order B or C, the date/time information obtained in step 110 is also read out simultaneously from the storing section 56. The photographic image data, customer information, and order information (and date/time information) are transmitted to the order processing apparatus 12 via the communication network 14, and the image photographing process stops. Step 136, together with the wireless communication section 58, which transmits the information, is included in the transmitting means of the present invention.

When the customer photographs images multiple times, all of the obtained photographic image data are read out and respectively sent to the order processing apparatus 12 in step 136. It is preferable that particularly large image data be compressed before being transmitted, to reduce the time required for transmitting. In this process, one of the Orders A, B or C is presented to the order processing apparatus 12.

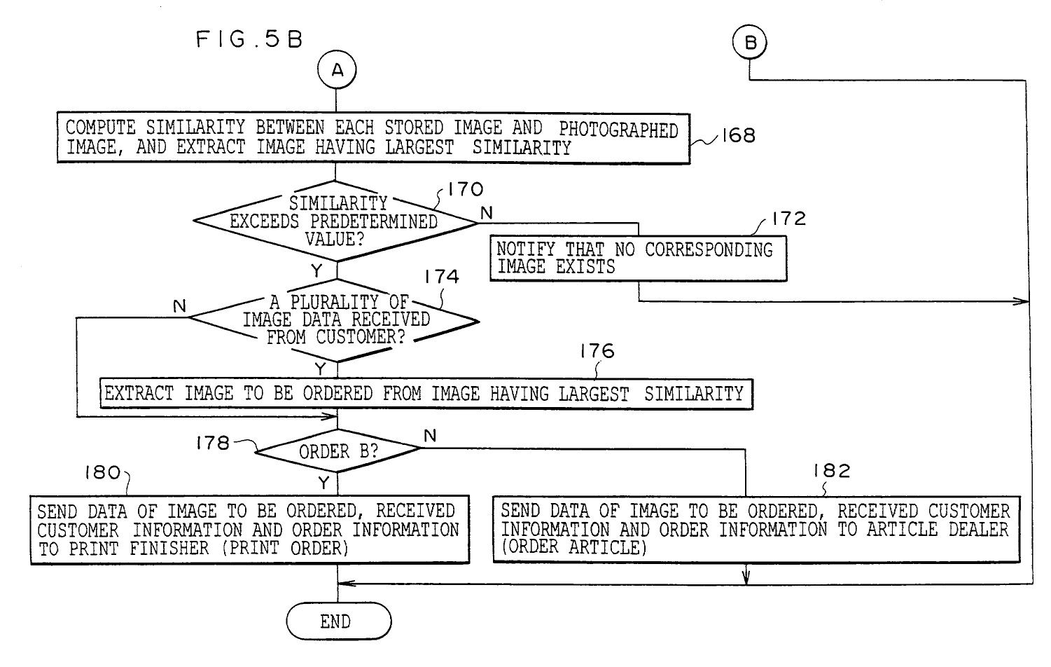

Next, referring to the flowcharts of FIGS. 5A and 5B, order receiving processing will be described. The order receiving processing is carried out after the order processing apparatus 12 receives the necessary information (the photographic image data, the customer information, order information, and the date/time information) from the portable device 46 of the customer. When the order processing apparatus 12 receives information from the portable device 46, the communication control device 42 functions as an order receiving means of the present invention.

In step 150, a CPU 12A of the apparatus 12 refers to the order type information included in the order information from the customer, and then determines whether or not the order type is Order A. When the result of step 150 is affirmative, the sequence continues to step 152. In step 152, the apparatus 12 selects an appropriate print finisher 16, who is selected to receive the order based on the “print receiving method” included in the order information, and further determined by the address of the customer included in the customer information. Then, the apparatus 12 places the printing order (Order A) by sending the photographic image data, the customer information, and the order information received from the customer to the PC 18 of the selected print finisher 16 via the communication network 14.

The selected print finisher 16 produces photographic prints at the size and number designated by the order information data received on the PC 18 via the communication network 14, and delivers the finished prints so that the customer can receive the prints in the manner designated. The customer can thus receive the photographic prints finished in accordance with the printing specifications (size of prints, number of prints, and receiving method) that was designated.

When the customer has selected the Order B or C, however, the result of step 150 is negative, and the sequence continues to step 154. In step 154, it is determined, based on the date/time information of photographing, whether the image to be ordered by the customer exists in the image database in the HDD 40. In the present embodiment, all or some of the images that can be potentially ordered may be stored in the image database. The HDD 40 of the order processing apparatus 12 corresponds to the storing means of the present invention.

When the order processing apparatus 12 is configured such that video data (original image data) stored in the image database of the HDD 26 of the television broadcasting station 22 and the broadcasting date/time of the video data are, with respect to all television broadcasting stations 22, periodically downloaded (with article information being simultaneously downloaded with regard to data to which article information has been added) from the PC 24 via the communication network 14 and stored in the image database of the HDD 40, all image data for which there exists the potential to be ordered as the order B or the order C is stored in the image database of the HDD 40 of the order processing apparatus 12. It should be noted that, in this aspect, the determination in step 154 becomes unconditionally affirmative.

In the present embodiment, immediately after the customer photographs the desired image displayed on the television 32, the order processing apparatus 12 receives either Orders B or C. It is thus sufficient to save the data for only a relatively short period of time (e.g., from about several hours to up to one day) from when the image was broadcast. Accordingly, even in cases where all the data from the television broadcasting station 22 are stored in the image database in the HDD 40 as in the above-described scenario, the storage capacity of the HDD 40 need not be extremely large to store all of the image databases.

When the order processing apparatus 12 is configured such that, of images (dynamic image) that each television broadcasting station 22 has broadcast, only image data (dynamic image) broadcast during time frames for which there exists a high potential for the images to be ordered as order B or order C (e.g., time frames during which audience ratings are relatively high, or time frames in which images showing articles that become the target of order C being marketed are broadcast) and the broadcasting date/time of those images (and also article information with regard to data to which article information has been added) are collected from all of the television broadcasting stations 22 and stored in the image database of the HDD 40, part of image data of certain images for which there exists the potential to be ordered as order B or order C is stored in the image database of the HDD 40 of the order processing apparatus 12.

The present invention is not limited to setting up an image database in the HDD 40 of the order processing apparatus 12, and thus it is not necessary for possible image data for Order B or C to be stored in the HDD 40.

When the result of step 154 is affirmative, the sequence continues to step 158. In step 158, the order processing apparatus 12 extracts, from the image database in the HDD 40, the image data of the image each television broadcasting station 22 broadcast (distributed) around the photographing time (e.g., image data broadcast several seconds to several tens of seconds before and after the photographing time) indicated by the date/time information received from the customer. At this time, the order processing apparatus 12 takes into consideration that there may be a difference or gap between the time shown by the clock function of the portable device 46 and the actual time. The extracted image data is then stored in a predetermined working area provided in the storage area in the RAM 12 C or the HDD 40. Then, the sequence continues to step 168.

When the result of step 154 is negative, the sequence continues to step 160. In step 160, the order processing apparatus 12 transmits, via the communication network 14, the date/time information received from the customer to the PC 24 of the identified television broadcasting station 22, and requests them to transfer the image data of the image broadcast before and after the time slot by the station 22 at and around the time indicated by the transmitted date/time information. In the next step 162, it is determined whether the requested image data from the television broadcasting station 22 has been received or not, and the sequence remains on stand by until the result of step 162 becomes affirmative.

Once the PC 24 of the particular television broadcasting station 22 is requested to transfer the image data, the PC 24 extracts ,from the image database in the HDD 26, the image data that the television broadcasting station 22 broadcast around the time indicated by the date/time information received from the order processing apparatus 12, and transfers the image data to the order processing apparatus 12 via the communication network 14. When the order processing apparatus 12 receives the image data, the result of step 162 becomes affirmative and the sequence continues to step 164. In step 164, the image data received from the PC 24 of the particular television broadcasting station 22 is stored in the working area of the RAM 12C or the HDD 40 of the order processing apparatus 12.

In the next step 166, it is determined whether the order processing apparatus 12 has received the image data from all the television broadcasting stations 22. When the result of step 166 is negative, the sequence returns to step 160 and repeats the steps 160 to 166 until the result becomes affirmative. As a result, data of images (images for which there exists the potential to have been displayed on the television 32 that the customer had been viewing) broadcast at and around the date/time represented by the photographing date/time information received from the customer is respectively collected and stored from the images (dynamic image) broadcast by all of the television broadcasting stations 22.

In step 168, each image data stored in the working area of the RAM 12C or the HDD 40 is pattern-matched with the photographic image data received from the customer, and the similarities between them are computed. Then, the image data having the greatest similarity with the photographed image data is extracted. When a plurality of photographic image data is received from the customer, the similarity is computed using the photographic image data obtained by the first photographing, i.e., the photographic image data obtained when the customer photographed the entire screen in the display range of the television 32.

The similarity between a pair of images, the image represented by the photographed image data from the customer (“image A”) and the image represented by any one of the images among the image data stored in the working area of the RAM 12C or the HDD 40 (“image B”), may be computed in the following manner. First, the number of pixels in the vertical and transverse directions of the image is normalized by pixel skipping or resolution conversion.

Then, the density level and the dynamic range must be normalized while considering the possibility that the density level and gradation of the image represented by the photographic image data differs from those of the actual image, depending on the exposure control capability of the device used for photographing (the portable device 46 of this embodiment). The density level and the dynamic range are normalized by converting the pixel value (density value or intensity value) of each pixel in the images A and B in accordance with the following formulae.

a′_{c}(i,j)=k·(a_{c}(i,j)−mean(A_{c}))/(max(A_{c})−min(A_{c}))

b′_{c}(i,j)=k·(b_{c}(i,j)−mean(B_{c}))/(max(B_{c})−min(B_{c}))

wherein, suffix C represents any one of color elements (red (R), green (G) and blue (B)), k represents a coefficient, a_{c}(i,j) represents the pixel value of the image A on the coordinates (i,j), b_{c}(i,j) represents the pixel value of the image B on the coordinates (i,j), and mean (X), max (X), min (X) represent the mean values, maximum values, and minimum values of the pixel value of the image X.

Then, residual D is computed for the images A and B whose density level and the dynamic range have been normalized.

$$D = \sqrt{{\sum }_{i} {\sum }_{j} {( {a}^{′} ( i , j ) - {b}^{′} ( i , j ) )}^{2}}$$

The residual D decreases as the similarity between the images A and B increases. The residual D is obtained for each color element (R, G and B) and then multiplied.

Similarity Y is obtained from the multiplied residue D using the formula below.

Y=1/D or Y=−D

Thus, the value of similarity Y becomes larger as the similarity between the images A and B increases. The apparatus 12 seeks the maximum value of the similarity Y between the images A and B by repeatedly conducting the above computation (normalization of the number of pixels, normalization of the density level and the dynamic range, computation of the residual D, and computation of the similarity Y) while shifting the relative positions of the image A and B by ±n pixels independently in the vertical and horizontal directions of the images. The obtained maximum value of the similarity Y is employed as the similarity Y of the images A and B.

The computation of image similarity is not limited to the method described above, and various known methods can be employed. For example, image similarity may be computed by focusing on the edges and shapes in scenes as disclosed in Japanese Patent Application Laid-open No. 2001-84274. The advantage of this method is that no normalization of the density level and the dynamic range is required since the edge information in the image is focused upon.

In the next step 170, it is determined whether the similarity in the image data amongst the images having the largest similarity exceeds a predetermined value. The steps 154 to 170 are included in the later-described order identifying means of the present invention.

The result of step 170 is negative in the following cases. When, for example, the image photographed by the customer does not properly capture the screen of the television (i.e., the size or the degree of misalignment exceeds the minimum tolerance); a serious exposure problem or defocusing occurred in the photographed image; the time represented by the received date/time information differs from the actual photographed date because of an error in setting the date of the portable device 46; and when the apparatus 12 received an image whose object is not on the display of the television 32 due to the customer's faulty operation of the portable device 46, or the like. In these cases, it is difficult to continue the order processing sequence so the result of step 170 becomes negative. When the result of step 170 is negative, the sequence continues to step 172. In step 172, a message is sent to the portable device 46 notifying the customer that there is no corresponding image, and the sequence stops.

On the other hand, when the result of step 170 is affirmative, the sequence advances to step 174, where it is determined whether a plurality of photographic image data has been received from the customer. When the result is negative, the sequence advances to step 178. When the result is affirmative, a plurality of candidate images is in the image that the customer photographed at the first photographing (i.e., the image represented by the image data having the greatest similarity). Hence, in step 176, image data corresponding to each candidate image (“candidate image data”) are separately extracted from the image data having the greatest similarities. Then, the magnification of the extracted candidate image data is matched to the magnification of the photographic image data obtained by re-photographing (i.e., the image data obtained by being photographed such that only the candidate image is in the range of photographing). Consequently, similarities between respective candidate image data and the photographed image data obtained by re-photographing is computed. Finally, the candidate image data having the greatest similarity with the photographed image data obtained by the re-photographing is extracted.

In the next step 178, it is determined whether the customer ordered the order B or not. When the result is affirmative, the sequence continues to step 180, where an appropriate print finisher 16 is selected for the print order, as in step 152. Then, the apparatus 12 places the printing order (Order B) by sending the image data (original image data of the image to be ordered) extracted in step 168 or 176, the customer information and the order information to the PC 18 of the selected print finisher 16 via the communication network 14.

The selected print finisher 16 produces photographic prints at the size and number designated by the order information received on the PC 18 via the network 14, and delivers the finished prints so that the customer can receive the prints in the manner designated.

The customer can thus receive the photographic prints finished in accordance with the printing specifications (size of prints, number of prints, and receiving method) that was designated. The image quality of the photographic image data obtained by photographing using the portable device 46 is often low due to factors such as inferior image display capability of the display medium, and the photographing conditions. However, the original image data stored in the image database of the television broadcasting station 22 is of high resolution and high quality, so the customer can obtain high quality photographic prints by ordering prints via the Order B.

When the result of step 178 is negative, however, the customer has ordered Order C, and article information is added to the image data of the object to be ordered. Accordingly, in step 182, the apparatus 12 identifies the article dealer 28 who deals in the article that the customer ordered based on the article dealer ID included in the article information added to the image data. The identifying step for finding an appropriate article dealer 28 is included in the order identifying means of the present invention. Then, the apparatus 12 places the Order C by sending the image data (of the object to be ordered) extracted in the step 168 or 176, the customer information, the order information, and the article information to the PC 30 of the identified article dealer 28 via the communication network 14. The above-mentioned step 182, together with the step 180, is included in the order processing means of the present invention.

The article dealer 28 packs the article corresponding to the article ID included in the received article information at the number designated by the order information, and delivers the article so that the customer can receive the article in the manner he/she designated at the designated address. The customer can thus receive the article in accordance with the specification (number of articles and receiving method) designated.

Second Embodiment

Next, the second embodiment of the present invention will be described. Because the structure of the second embodiment is identical to that of the first embodiment, the identical components are denoted by the same reference numerals, and redundant description thereof will be omitted. An operation of the second embodiment will be described below.

In the second embodiment, the television broadcasting station 22 adds to the broadcast (distributed) images an identification code 70 (e.g., barcode) in advance, which indicates a predetermined identification information. As shown in the example in FIG. 4D, the identification codes 70 are added to a plurality of images that can be ordered for printing as Order B (images with original image data stored in the image database of the HDD 26 ) and to a plurality of images whose objects are articles that can be ordered as Order C (articles that the article dealer 28 deals in).

In the second embodiment, the identification information represented by the identification codes 70 attached to images orderable for printing is used for identifying individual images that can be ordered for printing. The identification information may include the information used for identifying the television broadcasting station 22 that owns the image data. The identification code 70 corresponds to the first identification image of the present invention. When the identification code 70 is added to an image whose object is an orderable article, the information indicated by the identification code 70 is the article information of the article. The article information may include an article ID, an article dealer ID who deals in the article, and the like. The identification code 70 corresponds to the second identification image of the present invention.

On the receiving side of the broadcast, the identification code 70 is displayed on the television 32 when the television 32 displays the images that can be ordered through Order B (images where the original image data is stored in the image database of the HDD 26) and the images of objects that are articles that can be ordered through Order C (articles the article dealer 28 deals in).

In the second embodiment, when the same image photographing process as in the first embodiment is executed and the customer is to photograph an object using the photographing section 54 of the portable device 46, a process selection screen as shown in FIG. 3E is displayed on the display 50 of the portable device 46. When the customer selects process 3 (Order B) or process 4 (Order C), a message initially appears for the customer on the process selection screen, as shown in FIG. 3E. The message informs the customer that when selecting a print order through Order B, or when ordering an article through Order C, only the image of the object to be ordered and the corresponding identification code 70 displayed on the television 32 should be photographed with the photographing section 54. This is done by aiming the portable device 46 at the television 32 and adjusting the distance between them accordingly.

Therefore, in the second embodiment, when the customer selects the either Order B or C, the photographic image data that represents the image to be ordered and the identification code 70 attched to the image is transmitted from the portable device 46 to the order processing apparatus 12.

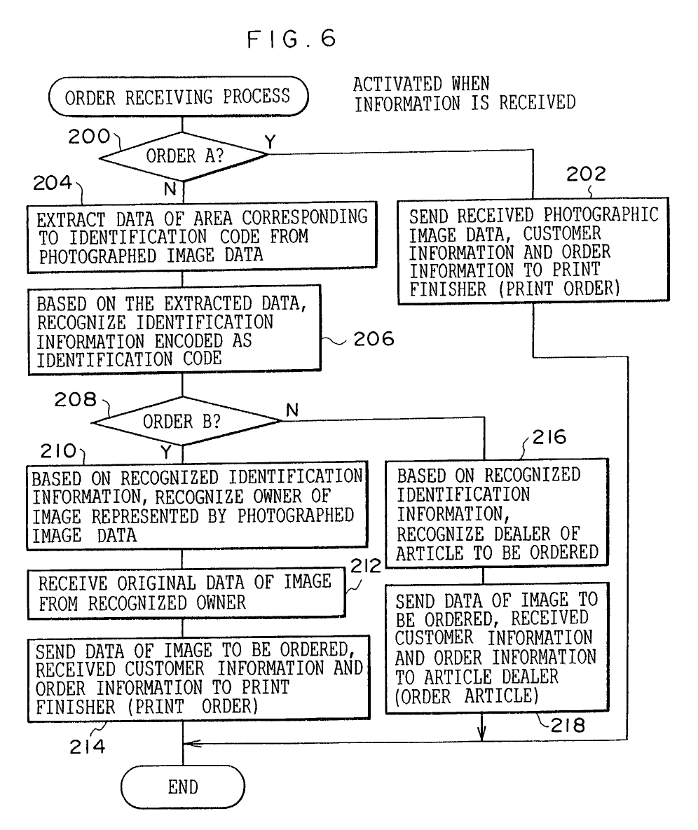

Referring now to the flowchart in FIG. 6, the order receiving process executed by the order processing apparatus 12 relating to the second embodiment will be described. In step 200, it is determined whether the order type is Order A or not, based on the order type information included in the order information received from the customer. When the result is affirmative, the sequence continues to step 202, where an appropriate print finisher 16 is selected as in step 152 in FIG. 5A. Then, the apparatus 12 places the printing order (Order A) by sending the photographic image data, the customer information and the order information to the PC 18 of the selected print finisher 16.

When the order type is Order B or C, the result of step 200 is negative, and the sequence continues to step 204. In step 204, the data of the area corresponding to the identification code is extracted from the photographic image data received from the customer. In the next step 206, based on the extracted area data from in step 204, the content of the identification information that was encoded as the identification code is recognized. In step 208, it is determined whether or not the order type is Order B.

When the result of step 208 is affirmative, the sequence advances to step 210. When the order type from the customer is Order B, the image represented by the photographic image data includes the image that can be ordered for printing and the identification code attached to the image. The identification information represented by the identification code is the information used for identifying each image that can be ordered for printing. The identification information may include the information used for identifying the television broadcasting station 22 that owns the image data. Accordingly, based on the recognition result of the identifying information of step 206, the television broadcasting station 22, which owns the original image data of the image (to be ordered) represented by the photographic image data, is recognized in step 210.

In step 212, the order processing apparatus 12 transmits the identification information recognized in step 206 to the PC 24 of the television broadcasting station 22 recognized in step 210, and requests transferring the image data of the image identified by the identification information. Once the PC 24 of the particular television broadcasting station 22 is requested to transfer the image data, the PC 24 extracts the image data from the image database in the HDD 26 and transfers the image data to the order processing apparatus 12. The order processing apparatus 12 receives the image data so as to obtain the original image data of the ordered image. Steps 204 to 212 correspond to and are included in the order identifying means of the present invention.

Next, in step 214, an appropriate print finisher 16 is selected for the printing order. The order processing apparatus 12 places the printing order (Order B) by sending the image data (original image data of the image of the object to be ordered) obtained in step 212, the customer information and the order information to the PC 18 of the selected print finisher 16. The customer can thus receive the photographic prints finished in accordance with the printing specification (print size, number of prints, and receiving method) designated.

When the result of step 208 is negative, the sequence continues to step 216. When the order type from the customer is Order C, the image represented by the photographed image data includes the image whose object is an article that can be ordered and the identification code added to the image. The identification code represents the article information of the article which is the object of the corresponding image. In step 216, based on the article information recognition result of step 206, the order processing apparatus 12 recognizes the article dealer 28 that deals in the article in the image represented by the photographic image data. Steps 204 to 208 and step 216 are included in the order identifying means of the present invention.

In step 218, the order processing apparatus 12 places the Order C by sending the identification information (article information) recognized in step 206, the customer information, and the order information to the PC 30 of the article dealer 28 recognized in step 216. The customer can thus receive the article that is packed and delivered by the article dealer 28 in accordance with the specifications (number of prints and receiving method) designated.

In the above-described embodiments, the display medium described is a television. However, the display medium in the present invention is not limited to televisions only and may also be an electronic ad board, electronic paper, film projecting equipment, or information processing equipment (e.g., a computer display or a cellular phone) that displays information received via a computer network such as the Internet.

Electronic ad boards are disposed at many places and each electronic ad board is individually administrated by different managers (administrators) as are the images displayed thereon. When an electronic ad board is used as the display medium in the present invention, there may be many electronic ad boards from which a customer photographs images. It is therefore difficult to identify the specific image represented by the photographic image data using only the photographing date/time information without identifying the specific electronic ad board from which the customer photographed the image. Similarly, film projecting equipment is found in many movie theaters and the images (dynamic images) displayed thereon are administrated by the administrator of the equipment. It is therefore difficult to identify the specific image represented by the photographic image data using only the photographing date/time information without identifying the specific film projecting equipment (or the theater) from which the customer photographed the image.

When a customer photographs an image (dynamic image) displayed on an electronic ad board or film projecting equipment for ordering the Order B or C, and no identification code is attached to the displayed images, it is preferable to provide the portable device 46 with a positioning device. For example, the portable device 46 can include a function for recognizing the customer's current position by receiving signals from a plurality of Global Positioning Satellitess (GPS function). In this case, in the image photographing process in FIG. 2, the portable device 46 can be configured so as to be able to obtain the positional information indicating the current position (photographing position) using the GPS function in step 110, and then transmit the positional information to the order processing apparatus 12. It is preferable that the order processing apparatus 12 identifies the specific display medium (e.g., electronic ad board, film projecting equipment, movie theater, etc.) from which the customer photographed the image, based on the received positional information, and narrows down the image to be ordered represented by the photographic image data using the photographing date/time information. The order processing apparatus 12 can thus easily identify the image to be ordered even when the display medium is an electronic ad board or film projecting equipment. In this case, the communication control device 42 corresponds to the order receiving means of the present invention. The identification may be conducted by the order identifying means of the present invention. When the conversion period of images displayed on the display medium is relatively long, e.g., several hours to several days, the order identifying means may narrow down the image (of the object to be ordered) represented by the photographic image data using the positional information without using the photographing date/time information.

Regarding images that are received via, for example, the Internet and displayed on the display of an information processing device (e.g., a computer or a cellular phone), it is difficult to identify the image represented only by the photographic image data from the photographing date/time and place (positional) information. Hence, the identification code described in conjunction with the second embodiment may be attached to the images displayed on the display medium. The order processing apparatus 12 can thus obtain the original image data of the image to be ordered by extracting the identification code from the image represented by the photographic image data. The image represented by the photographic image data may include a character image such as an address (e.g., URL) of the image. In this case, the order processing apparatus 12 obtains the original image data of the image by extracting the character image and conducting character recognition to recognize the address of the image. Further, a character image indicating the name of a company that deals in the article in the image, or an image indicating the logo of the company may be added to the image displayed on the display medium. The order processing apparatus 12 can thus obtain the original image data of the image by recognizing or analyzing the character image or the logo image extracted from the image represented by the photographic image data, and can recognize the company that deals in the article.

In the first embodiment, identification of the image data of the article to be ordered is determined by comparing the similarities with the photograph image data, and the identifying process is completed by selecting the data with the greatest degree of similarity above a predetermined value. However, determination of the image is not limited to this method only. By transmitting a plurality of image data to the portable device 46 in descending order of similarity, each image may be displayed on the display 50 of the portable device 46 so that the customer can select the image themselves.

The image photographing device used in the examples so far in conjunction with the portable device 46 is characterized as being a conventional cellular phone equipped with a photographing means and data communication means, and has a predetermined image photographing program installed therein. The image photographing device, however, is not limited to this kind of portable device 46 only and may also be a personal digital assistant (PDA), a wearable computer, or a mobile computer equipped with the photographing means and the data communication function. The image photographing device of the present invention may be a combination of a digital still camera and a cellular phone, which is capable of communicating using Bluetooth or other communication method.

There are cases when multiple images of potential articles to be ordered are displayed on the portable device 46. When a PDA is used as the image photographing device in the present invention, because the PDA generally has a touch sensor on the display, the customer can designate the images to be ordered by manually writing the information. This eliminates the need for re-photographing the image even when no identification code 70 has been attached to the image. For example, as shown in FIG. 3C, the customer designates the image by manually circling the image of the object to be ordered.

Although the order type has been described in conjunction with the printing order (Order B) and the order for an article (Order C), the present invention is not limited thereto. Alternatively, the original image data itself of the photographed image may be ordered. In other words, not only static image data, but also dynamic image data can be ordered in the present invention. When the customer orders the dynamic image data, the image data may be recorded on a recording medium, such as a CD-R, MO, ZIP, and DVD and returned to the customer. Also, the customer may download the dynamic image data from a server or the like.

Furthermore, orders of contents (articles) relating to the photographed image (of the object to be ordered) can be made possible. Such orders are hereinafter referred to as Order D. The image of the object to be ordered can be a photographed image of a scene from a movie, drama, video game and the like displayed on a displaying means such as a television 32. Specific examples of related contents for Order D that can be ordered include videos or DVDs of the movie or drama being viewed, CD-ROMs of the video game software being played, CDs of music recordings from the image being photographed, and original novels upon which the watched movies and dramas were based. Also, if the image of the object to be ordered can be obtained by photographing a scene of an advertisement for a specific article displayed on the displaying means such as the television 32, articles relating to the advertisement can be ordered. Examples of related articles that can be ordered include the specific articles advertised in the advertisement and CD recordings of the advertisement music, just to name a few.

In order to make Order D possible, image data that includes related articles that may be ordered (contents) are attached with the corresponding article information for identifying the related articles and pre-stored among the dynamic image data of the image DB.

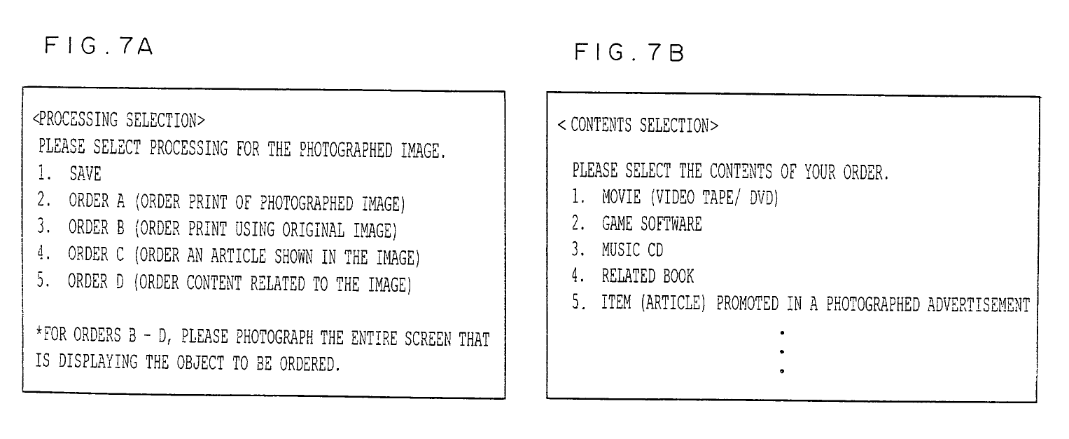

As illustrated in the example in FIG. 7A, at the time of photographing, a process selection screen that includes processing of the fifth selection (Order D) as an option is displayed on the display 50 of the portable device 46 for ordering contents (articles) relating to the photographed image. When Order D is selected, the next selection comprises a plurality of content names that can be ordered from a content selection screen displayed on the display 50, as shown in FIG. 7B. In this fashion, the customer selects the content classification and based on the result of that selection, the order processing apparatus 12 distinguishes the article information and identifies the corresponding content(s) of the object to be ordered.

Examples were given above for cases where a customer photographed an image displayed on a display, either for ordering prints of the image or for ordering the actual article being displayed. However, orders and not limited to these styles only. Customers may also photograph articles being exhibited in shops and order the exhibited articles that way. The stores have information for each of the exhibited articles stored in a storing device of a computer server, which is connected with a communication network 14. Article information used can include the article name, price, status of stock, etc., while article verifying information for the photographed object can include characteristics of the article, such as shape, color, color density, and the like. In addition, information for identifying the article from a photographic image can be stored in places such as the article's manufacturing site or a management center. Another alternative is attaching an IC tag to the article, with an IC tag sensor on the display shelf that is connected to a server computer. This allows the obtainment of verification information for the displayed article in real time.

When a customer sees an article amongst those displayed that he or she desires, the customer can take a photograph of the article with the photographing section 54 of the portable device 46. The photographic image data obtained from the photograph is sent to the order processing apparatus 12, and the photographed article is identified by its photographic image data and then ordered. Information regarding the photographed place is attached in the photograph image data sent to the order processing apparatus 12. That place information can be the name of the store, in which case the customer uses the control section 52 to create and attach information on the site where the photographing took place. If the portable device 46 is equipped with GPS functions, then the GPS can be used to automatically produce information on the site where the photographing took place.

When articles are ordered by the customer using this system, the order processing apparatus 12 identifies stores displaying those articles, based on the photographic image data and place information received from the customer. The order processing apparatus 12 then communicates with the identified store's computer server and can confirm the existence of the article at said store. Then, the order processing apparatus 12 gathers article verification information from the article's manufacturer and management centers and verifies that information with the photographic image data sent by the customer. If the article verification information is photographic image data, the order processing apparatus 12 verifies the article by computing similarities of the articles in question. If the article verification information is based upon special characteristics of the article, the order processing apparatus 12 verifies by comparing to what extent the displayed article's characteristics match up with the verification information. Based upon this verification, the photographed object is verified as the article, and an ordering process is initiated for the verified article. In this fashion, customers can order articles exhibited in stores and the like simply by photographing said articles.

Also, identification plates such as bar codes may be placed next to each exhibited article in stores. When customers order a specific article that is exhibited in the store, the article and the identification plate near said article must be included in the photograph that the customer takes. The order processing apparatus 12 extracts the identification plate from the photographic image data that it receives and based upon the extracted portion with the identification plate, it is able to verify the photographed article as the displayed article.

Furthermore, the store can overcome reliance on articles that are actually exhibited and display printed images of articles on a paper medium, such as a poster (also included in the displaying means of the present invention). In this mode of exhibiting, an IC tag is attached to the poster along with a tag sensor near the exhibit. When the tag sensor is connected to the computer server, the computer can obtain and manage the article being exhibited. In order to further facilitate article verification of the object's photographed image, the aforementioned identifying plate can be attached to the poster itself as well.

The order processing apparatus of the present invention has the excellent effect of creating an easy ordering environment for the customer, due to several key characteristics. Firstly, photographic image data produced by the customer with a photographing means in relation to an image displayed on a displaying means is used to order the image, or the object of the image itself. Also, the order information relaying the contents of the order is obtained directly from the customer. Based on the obtained photographic image data, at least one of the following is carried out: identification of the image of the photographed object; identification of the article as indicated by the photographic image data, which includes the photographic image or the photographed object in the image of an object for an order; and identification of articles relating to the aforementioned image of an object for an order. Based on the above-described identification, an order can be processed in accordance with the order information obtained by the customer. These factors combine to exponentially facilitate the article and image ordering process for the customer.

In the present invention, when the photographic image data includes a plurality of candidate images of objects to be ordered, information for identifying the image of the object to be ordered is obtained. The excellent effect of the present invention is that based on that obtained information, the image of the object to be ordered is determined with even greater accuracy, even if a plurality of candidate images exist in the photographic image data.

Further, in the present invention, there is an excellent effect in that a photographed image can be identified in a short period of time. This is made possible by obtaining at least the photographing time information and/or the information indicating the place of photographing. A plurality of image data that is or might be displayed on the display medium can be stored by the storing means, which can be indicated by at least one of the photographing date/time information and/or the photographing place information. The image data that might be the image corresponding to the photographed image is extracted and the extracted image of the data can be collated with the photographic image data. Identification of the image of an object for an order can be carried out in this manner.

Furthermore, image data of articles that may have been photographed as an article to be ordered can be identified by the place information from the storing means, which has stored therein a plurality of image data of articles that may be ordered via photographing by the customer. By extracting this data from the storing means and verifying it with the photographic image data, the object of the photograph, which is the object to be ordered, can be quickly identified. Hence, in addition to quickly identifying the photographed image, the present invention has the excellent effect in that the article to be ordered may also be identified in a short period of time.

Also, in the present invention, a first identified image is attached to the image displayed on the displaying means for identifying individual images, and that first identified image that is included in the displayed photographic image data is extracted. If image identification for an article to be ordered is based on the extracted first identified image, in addition to the excellent effects mentioned above, the present invention also has the remarkable effect of being able to identify a photographed image in a short period of time.

Further, a second identification image for identifying the article as a photographed object in an image may be attached to the image displayed on the displaying medium. The second identification image, which is included in the image represented by the photographic image data, can be extracted and based on the extracted image, identification of the article as a photographed object in an image of an object for an order can be carried out. In this manner, in addition to the aforementioned effects, there is a remarkable effect in that identification of the photographed object in an image of an object for an order can be carried out easily and in a short period of time.

Furthermore, in the present invention, articles that might be photographed as an object for an order can have a display member placed nearby that displays identification information for identifying an article. The portion of the photographed image that includes the display member can be extracted, and if identification of an article as a photographed object in a photographic image is carried out based on the identification information indicated in the extracted portion of the image, identification of an article as a photographed object in a photographic image can be carried out easily and in a short period of time, in addition to the aforementioned remarkable effects.

The image photographing device of the present invention has a photographing section, which makes photographing an image displayed on a display medium or photographing an object for an order possible. The image photographing device is also configured with an inputting section for inputting the customer's order content relating to the photographed image. The image photographing device is also configured with a sending section for sending photographic image data generated by the customer's photographing and order information inputted via the inputting section, to the order processing apparatus. Because the image photographing device is thus configured, the present invention has a remarkable effect in that an environment can be created where a customer can easily place an order.

What is claimed is:

1. An order processing apparatus comprising:
order receiving means for receiving image data, which represents a photographed image generated by photographing, and information including order information that forms an order from a customer;
order identifying means for identifying an ordered article from the image data received by the order receiving means; and
order processing means for carrying out, on the basis of the result of identification by the order identifying means, predetermined order processing in accordance with the order represented by the order information.

2. The order processing apparatus of claim 1, wherein the image data is produced by photographing one of an object to be ordered and an image displayed on a display medium.

3. The order processing apparatus of claim 1, wherein the order identifying means identifies an image that is an object for an order from the image data received by the order receiving means.

4. The order processing apparatus of claim 3, wherein the order identifying means further identifies, from the identified image, the ordered article corresponding to a photographed object in the image.

5. The order processing apparatus of claim 3, wherein the order identifying means further identifies, from the identified image, the ordered article relating to the photographed image.

6. The order processing apparatus of claim 5, wherein the ordered article is at least one of the photographed image, a literary work relating to the photographed image, an article advertised by the photographed image, and a literary work relating to the article advertised by the photographed image.

7. The order processing apparatus of claim 6, wherein the photographed image is one frame of an image comprising a dynamic image.

8. The order processing apparatus of claim 3, further comprising storing means for storing, as an original image, the image data corresponding to an image displayed on a display medium, wherein the order identifying means identifies the image by checking the image data received by the order receiving means against the image data stored in the storing means.

9. The order processing apparatus of claim 8, wherein the predetermined order processing includes at least one of processing for printing the image using the original image data corresponding. to the photographed image, processing for placing an order for image printing to an outside agency, processing for sending the original image data to a person making an order, processing for recording the original image data onto a recording medium, and processing for placing an order for the ordered article to the outside agency.

10. The order processing apparatus of claim 1, wherein the order receiving means further receives information for identifying a photographed object that is an object for an order when a plurality of photographed objects that can become candidates for ordering appears in the image represented by the image data.

11. The order processing apparatus of claim 8, wherein the order receiving means receives, from the received information, at least one of date/ time information representing a date and time of the photographing, and place information representing a place of the photographing, and the order identifying means identifies the image that is an object for an order corresponding to the photographed image by extracting, from the image data stored in the storing means, image data specified by at least one of the date/time information and the place information and checking the extracted image data against the photographed image data.

12. The order processing apparatus of claim 11, wherein the image data received by the order receiving means is part of a dynamic image displayed on the display medium by a channel selected by the customer from a plurality of channels that relay dynamic images according to mutually separate schedules, the storing means stores data of the dynamic images relayed by each channel, and the order identifying means identifies the image that is an object for an order, using each channel as a unit, by extracting, from image data representing the dynamic images, an image group relayed near the date and time of photographing represented by the date/time information of the photographing.

13. The order processing apparatus of claim 11, wherein the image data received by the order receiving means is the image displayed on the display medium disposed at a predetermined place, and the image is administrated by a specific administrator.

14. The order processing apparatus of claim 13, wherein the information that the order receiving means receives together with the image data includes at least the place information, and the order identifying means specifies, on the basis of the photographed place information, the display medium on which the image was photographed and extracts, on the basis of the result of the specification, from the storing means the image data that potentially corresponds to the image represented by the received image data.

15. The order processing apparatus of claim 1, further comprising storing means for storing image data of articles for which there is a potential to be photographed by the customer for ordering, wherein the information received by the order receiving means includes place information designated by the customer, and the order identifying means identifies an article that is an object for an order by extracting from the storage means image data of an article specified by the place information and checking the extracted image data against the photographed image data.

16. The order processing apparatus of claim 2, wherein the image displayed on the display medium includes a first identification image for identifying separate images, and the order identifying means extracts the first identification image included in the received data and identifies the image that is an object for an order on the basis of the extracted first identification image.

17. The order processing apparatus of claim 16, wherein the image displayed on the display medium includes a dynamic image comprising a plurality of frame images, and the first identification image includes identification codes for identifying each frame.

18. The order processing apparatus of claim 8, wherein the storing means stores, together with the image data of the image displayed on the display medium, at least information for identifying an article corresponding to the photographed object in the image displayed on the display medium by corresponding the article-identifying information with separate image data, and the order identifying means identifies, on the basis of the article-identifying information, an article that is an object for an order after identifying the image that is an object for an order.

19. The order processing apparatus of claim 4, wherein the image data is produced by photographing an image displayed on a display medium and the image displayed on the display medium includes a second identification image for identifying a photographed object in the image, and the order identifying means extracts the second identification image added to the image represented by the image data received by the order receiving means and identifies the ordered article on the basis of the second identification image.

20. The order processing apparatus of claim 1, wherein the photographed image of an article includes a display member that is disposed near the article and on which identification information for identifying the article is displayed, and the order identifying means extracts from the image data an image portion corresponding to the display member included in the photographed image and identifies the article that is an object for an order on the basis of the identification information represented by the extracted image portion.

21. An image photographing device for use with an order processing apparatus for processing an order on the basis of photographed image data that has been received, comprising:
a photographing section for photographing at least one of an object to be ordered and an image displayed on a display medium and generating image data therefor;
an inputting section for inputting order information relating to an image photographed using the photographing section; and
a transmitting section for transmitting to the order processing apparatus the image data and the inputted order information.

22. An order processing system comprising:
an order receiving device for receiving image data, which represents a photographed image generated by photographing, and information including order information that forms an order from a customer;
an order identifying device for identifying an ordered article from the image data received by the order receiving device; and
an order processing device for carrying out, based on the result of identification by the order identifying device, predetermined order processing in accordance with the order represented by the order information.
